(19) United States
(12) Patent Application Publication
(10) Pub. No.: US 2017/0064469 A1
(43) Pub. Date: Mar. 2, 2017

(54) HEARING DEVICE

(71) Applicants: Oticon A/S, Smørum (DK); Bernafon AG, Berne (CH)

(72) Inventors: Brian SPIDSBJERG, Smørum (DK); Michael Frank PETERSEN, Smørum (DK); Lars MONROY, Kongens Lyngby (DK); Wilfried SCHILD, Berne (CH); Andreas INGOLD, Berne (CH); Stefan JOST, Berne (CH); Rune SØ, Smørum (DK); Oliver SUNDBERG, København N (DK)

(73) Assignees: Oticon A/S, Smørum (DK); Bernafon AG, Berne (CH)

(21) Appl. No.: 15/251,683

(22) Filed: Aug. 30, 2016

(30) Foreign Application Priority Data
Aug. 31, 2015 (EP) 15183090.8

(51) Int. Cl. H04R 25/00

(52) U.S. Cl. CPC H04R 25/556

(57) ABSTRACT

A hearing device comprising a connector for a wired electrical connection between the hearing device and an accessory device is disclosed. The connector comprises a number of connection members adapted to engage with corresponding connection members of a plug member of the accessory device, wherein the hearing device comprises:
one or more guide holes configured to engagingly receive corresponding guide arms of the accessory device or
one or more guide arms configured to be engagingly inserted into corresponding guide holes of the accessory device.

### FIELD

The present disclosure relates to a hearing device having a connector for a wired electrical connection between the hearing device and an accessory device. More particularly, the disclosure relates to a hearing device having a connector for a wired electrical connection between the hearing device and an accessory device, wherein the connector comprises a number of connection members adapted to engage with corresponding connection members of a plug member of the accessory device.

### BACKGROUND

It is known to provide a hearing device with a connector for a wired electrical connection between the hearing device and an accessory device. Most often the hearing device is equipped with pins protruding from the connector and being configured to be inserted into corresponding sleeves provided in the accessory device.

The electrical contact between the pins and sleeves can be established as long as there is contact between the inner portion of the sleeves and the pins. This contact can be maintained as long as the inner portions of the sleeves provide force against the pins. When the sleeves are deformed/overstressed by the pins due to excessive movement, rotation or misaligned insertion during assembly or in use, the required contact and force will no longer be present and thus no reliable electrical connection can be maintained between the hearing device and an accessory device. Accordingly, the accessory device may have to be discarded.

Therefore, there is a need to provide a solution that allows for increasing the service life of the accessory device and establishing an electrical connection between the hearing device and an accessory device even when the accessory device has been connected to the hearing device a considerable number of times.

### SUMMARY

According to an aspect of the disclosure, the hearing device comprises a connector for a wired electrical connection between the hearing device and an accessory device, which connector comprises a number of connection members adapted to engage with corresponding connection members of a plug member of the accessory device, wherein the hearing device comprises:
one or more guide holes configured to engagingly receive corresponding guide arms of the accessory device or
one or more guide arms configured to be engagingly inserted into corresponding guide holes of the accessory device.

Hereby, the accessory device and the hearing device can be electrically connected in a manner in which torsion and flexion of the connection members (e.g. pins) of the hearing device relative to the connection members (e.g. sleeves) of the accessory device can be avoided. The one or more guide arms will ensure a well-defined insertion of the connection members (e.g. pins) of the hearing device into the connection members (e.g. sleeves) of the accessory device.

The hearing device comprises a connector that may be provided in any suitable location on the hearing device. It may be advantageous that the connector is provided at a distal end portion of the hearing device. It may be beneficial that the connector is provided at a plane structure configured to receive a corresponding structure of the accessory device.

The connector comprises a number of connection members adapted to engage with corresponding connection members of a plug member of the accessory device. The connection members may have any suitable geometric shape. It may be an advantage that the connection members have a basically cylindrical geometry or that the main portion of the connection members have a basically cylindrical geometry.

The hearing device may comprise one or more guide holes configured to engagingly receive corresponding guide arms of the accessory device.

The hearing device may comprise one or more guide arms configured to be engagingly inserted into corresponding guide holes of the accessory device.

The guide arms and guide holes may have any suitable corresponding geometry.

The hearing device may comprises two, three or four guide holes configured to engagingly receive corresponding guide arms of the accessory device.

Hereby, it is possible to provide a robust and reliable mechanical connection between the hearing device and the accessory device. The guide arms will take up any force that potentially could cause torsion or flexion of the pins. Accordingly, the use of guide holes configured to engagingly receive corresponding guide arms prevents stress of the pins.

The hearing device may comprise guide holes having an upper receiving surface extending parallel to a lower receiving surface.

Hereby, it is possible to provide a simple and easily producible guide hole. Further, it is possible to insert the guide arm into the guide hole in a one-dimensional manner provided that the insertion direction is parallel to the upper receiving surface and the lower receiving surface.

The hearing device may comprise guide holes having a rectangular cross-section. Hereby, it is possible to ensure that the accessory device and the hearing device can only be connected when they are arranged in a number of predefined configurations (with respect to the relative orientation) relative to each other.

The guide arms may comprise rounded edges. This could e.g. ease insertion of the guide arm into a corresponding guide hole. The guide hole may comprise corresponding, mating, rounded edges.

When the hearing device, or hearing aid, comprises more than one guide arm or guide hole, the guide arms or guide holes may have substantially similar or identical geometry. This could be true for only a part of the guide arms or guide holes. As an example if the hearing aid have three guide arms, two of them could be similar or identical, and the third could have a different shape and/or size.

The accessory device could be or comprise a battery, an FM antenna, a microphone, a direct audio in-put adaptor, an RF antenna, a telecoil, a coil for magnetic communication, a sensor, such as a temperature sensor or other type of sensor, a processor or a combination thereof. The communication between a processor in the hearing aid may then be able to communicate with the device or devices in the accessory. In case the accessory is a battery, this battery may be e.g. be used as a back-up or emergency battery in case the main battery of the hearing aid is low on energy. This could e.g. be useful if the main battery is rechargeable and the user does not have time to recharge the battery.

The height of the guide holes may be larger than the width of the guide holes. Hereby, the required insertion orientation of the accessory device can easily be spotted by the user. The ratio between the width and the height may be in the range 9:10 to 1:20, such as around 1:2, such as around 1:3, such as around 1:4, such as around 1:5, such as around 1:6, such as around 1:7. In case there are more than one guide arm, the guide arms may have the same or similar width to height ratio or different width to height ratios.

The connection members may extend parallel to the longitudinal axis of the connection members of a plug member of the accessory device and wherein the longitudinal axis of the guide holes extend parallel to the longitudinal axis of the guide arms. Hereby, it is ensured that the same direction of insertion is applied for both connecting the arm into the hole and for connecting the connector of the hearing device and the connection members of a plug member of the accessory device.

The guide holes may be provided next to the connector in less distance from the periphery of the hearing device than the connector. Hereby, a central positioning of the connector can be achieved. Accordingly, the connector will be less sensitive to any inaccuracy with respect to the way by which the accessory device and the hearing device are connected.

Two guide holes may be arranged at respective opposite sides of the connector. Hereby, a mechanical support is provided on both sides of the connector by inserting the guide arms into the guide holes. Accordingly, a strong and reliably mechanical support can be achieved.

The hearing device may comprise guide holes comprising a basically plane bottom surface that is acute-angled relative to the upper receiving surface or to the lower receiving surface. Hereby, it is possible to apply the bottom surface as a stop and apply guide arms having longitudinal axes that do not extend perpendicular to the bottom surface.

The system according to the disclosure is a system comprising a hearing device according to the disclosure and an accessory device, wherein the accessory device comprises a plug member having a number of sleeves or pins, which sleeves or pins are adapted to engage with a corresponding connector of the hearing device for establishing a wired electrical connection between the accessory device and the hearing device, wherein the accessory device comprises:
one or more guide arms configured to be engagingly inserted into corresponding guide holes of the hearing device or
one or more guide holes configured to engagingly receive corresponding guide arms of the hearing device.

Here the wired electrical connection is established by contacts and pins in the two devices, i.e. in the hearing device and the accessory device. The system according to the disclosure makes it possible to increase the service life of the accessory device and establish an electrical connection between the hearing device and an accessory device even when the accessory device has been connected to the hearing device a considerable number of times.

The system makes it possible to avoid torsion and flexion of the connection members (e.g. pins) of the hearing device or accessory device. Further, a well-defined insertion of the connection members (e.g. pins) of the hearing device into the connection members (e.g. sleeves) of the accessory device can be carried out.

The accessory device may comprise guide arms having an upper surface extending parallel to a lower surface. Hereby, the guide arms are suited for being abuttingly and retainingly received by a hole provided with corresponding parallel side structures.

The accessory device may comprise guide arms having a rectangular cross-section. Hereby, it is possible to define and control the insertion maneuver applied to connect the accessory device and the hearing device.

The height of the guide arms may be larger than the width of the guide arms. The ratio between the height and the width may be in the range 9:10 to 1:20, such as around 1:2, such as around 1:3, such as around 1:4, such as around 1:5, such as around 1:6, such as around 1:7. In case there are more than one guide arm, the guide arms may have the same or similar height to width ratio or different height to width ratios.

The sleeves or pins may extend parallel to the longitudinal axis of the guide arms. Hereby, it is ensured that both the guide arms and the pins/sleeves are suited for being moved along the direction during the connection of the hearing device and the accessory device.

The guide arms or guide holes of the accessory device may be provided next to the plug member in less distance from the periphery of the accessory device than the plug member. Hereby, a central positioning of the connector can be provided. Consequently, the connector will be less sensitive to any inaccuracy with respect to the way by which the accessory device and the hearing device are connected.

Two guide holes or two guide arms may be arranged at respective opposite sides of the plug member.

Accordingly, a mechanical support is achieved at both sides of the connector by inserting the guide arms into the guide holes. Therefore, a strong and reliable mechanical support can be achieved.

According to another aspect of the disclosure, the accessory device comprises guide arms comprising a basically plane front surface that is acute-angled relative to the upper surface or to the lower surface.

Hence, the upper surface may extend longer than the lower surface, or vice versa. Here front surface is the surface facing the other device, i.e. if the guide arms are located on the hearing instrument and the guide arms are to be received in an accessory, the plane front surface will face the Accordingly, it is possible to apply the bottom surface as a stop and apply guide arms having longitudinal axes that do not extend perpendicular to the bottom surface.

The accessory device may be or comprises a battery, an FM antenna, a microphone, a direct audio input adaptor, an RF antenna, a telecoil, a coil for magnetic communication, a sensor, such as a temperature sensor or other type of sensor, a processor or a combination thereof. The direct audio input (DAI) is a feature, which allows an external source to be directly connected as an input to the hearing instrument or device that bypasses the microphone or input device in the hearing instrument.

### BRIEF DESCRIPTION OF DRAWINGS

The aspects of the disclosure may be best understood from the following detailed description taken in conjunction with the accompanying figures. The figures are schematic and simplified for clarity, and they just show details to improve the understanding of the claims, while other details are left out. Throughout, the same reference numerals are used for identical or corresponding parts. The individual features of each aspect may each be combined with any or all features of the other aspects. These and other aspects, features and/or technical effect will be apparent from and elucidated with reference to the illustrations described hereinafter in which:

FIG. 1 A illustrates a schematic perspective view of a hearing device and an accessory device;

FIG. 1 B illustrates another schematic perspective view of the hearing device and the accessory device shown in FIG. 1 A;

FIG. 2 A illustrates a schematic cross-sectional view of a hearing device and an accessory device, wherein the accessory device is connected to the hearing device;

FIG. 2 B illustrates a schematic cross-sectional view of a portion of the hearing device and a portion of the accessory device shown in FIG. 2 A;

FIG. 3 A illustrates a schematic perspective view of a hearing device and an accessory device, wherein the accessory device is connected to the hearing device;

FIG. 3 B illustrates a schematic cross-sectional close-up view of a hearing device and an accessory device, wherein the accessory device is being connected to the hearing device;

FIG. 4 A illustrates a schematic perspective view of an accessory device,

FIG. 4 B illustrates a schematic side view of a hearing device and an accessory device, wherein the accessory device is connected to the hearing device,

FIG. 5 illustrates an accessory device and a hearing aid, and

FIG. 6 illustrates the accessory of FIG. 5 attached to the hearing aid of FIG. 5.

### DETAILED DESCRIPTION

The detailed description set forth below in connection with the appended drawings is intended as a description of various configurations. The detailed description includes specific details for the purpose of providing a thorough understanding of various concepts. However, it will be apparent to those skilled in the art that these concepts may be practiced without these specific details. Several aspects of the apparatus and methods are described by various blocks, functional units, modules, components, circuits, steps, processes, algorithms, etc. (collectively referred to as “elements”). Depending upon particular application, design constraints or other reasons, these elements may be implemented using electronic hardware, computer programs, or any combination thereof.

A hearing device may in particular be a hearing aid that is adapted to improve or augment the hearing capability of a user by receiving an acoustic signal from a user's surroundings, generating a corresponding audio signal, possibly modifying the audio signal and providing the possibly modified audio signal as an audible signal to at least one of the user's ears, or at least as a signal perceivable as audio by the user. The “hearing device” may further refer to a device such as an earphone or a headset adapted to receive an audio signal electronically, possibly modifying the audio signal and providing the possibly modified audio signals as an audible signal to at least one of the user's ears.

Such audible signals may be provided in the form of an acoustic signal radiated into the user's outer ear, or an acoustic signal transferred as mechanical vibrations to the user's inner ears through bone structure of the user's head and/or through parts of the middle ear of the user or electric signals transferred directly or indirectly to the cochlear nerve and/or to the auditory cortex of the user.

The hearing device is adapted to be worn in any known way. This may include i) arranging a unit of the hearing device behind the ear with a tube leading air-borne acoustic signals into the ear canal or with a receiver/loudspeaker arranged close to or in the ear canal such as in a Behind-the-Ear type hearing aid, and/or ii) arranging the hearing device entirely or partly in the pinna and/or in the ear canal of the user such as in an In-the-Ear type hearing aid or In-the-Canal/Completely-in-Canal type hearing aid, or iii) arranging a unit of the hearing device attached to a fixture implanted into the skull bone such as in Bone Anchored Hearing Aid or Cochlear Implant, or iv) arranging a unit of the hearing device as an entirely or partly implanted unit such as in Bone Anchored Hearing Aid or Cochlear Implant.

The hearing device 2 according to the disclosure may form part of a “hearing system” referred to as a system comprising one or two hearing devices or a “binaural hearing system” referred to as a system comprising two hearing devices where the devices are adapted to cooperatively provide signals perceivable as sound to both of the user's ears. The hearing system or binaural hearing system may further include auxiliary device(s) (also referred to as accessory device(s)) that communicate with at least one hearing device, the auxiliary device affecting the operation of the hearing devices and/or benefitting from the functioning of the hearing devices. A wired or wireless communication link between the at least one hearing device and the auxiliary device is established that allows for exchanging information (e.g. control and status signals, possibly audio signals) between the at least one hearing device and the auxiliary device. Such auxiliary devices may include at least one of the following: remote controls, remote microphones, audio gateway devices, mobile phones, public-address systems, car audio systems or music players or a combination thereof. The audio gateway is adapted to receive a multitude of audio signals such as from an entertainment device like a TV or a music player, a telephone apparatus like a mobile telephone or a computer, a PC. The audio gateway is further adapted to select and/or combine an appropriate audio signal of the received audio signals (or combination of signals) for transmission to the at least one hearing device. The remote control is adapted to control functionality and operation of the at least one hearing devices. The function of the remote control may be implemented in a Smartphone or other electron-is device, the Smartphone/electronic device possibly running an application that controls functionality of the at least one hearing device.

In general, a hearing device, especially a hearing aid, includes i) an input unit such as a microphone for receiving an acoustic signal from a user's surroundings and providing a corresponding input audio signal, and/or ii) a receiving unit for electronically receiving an input audio signal. The hearing device further includes a signal processing unit for processing the input audio signal and an output unit for providing an audible signal to the user in dependence on the processed audio signal.

The input unit may include multiple input microphones, e.g. for providing direction-dependent audio signal processing. Such a directional microphone system is adapted to enhance a target acoustic source among a multitude of acoustic sources in the user's environment. In one aspect, the directional system is adapted to detect (such as adaptively detect) from which direction a particular part of the microphone signal originates. This may be achieved by using conventionally known methods. The signal processing unit may include an amplifier that is adapted to apply a frequency dependent gain to the input audio signal. The signal processing unit may further be adapted to provide other relevant functionality such as compression, noise reduction, etc. The output unit may include an output transducer such as a loudspeaker/receiver for providing an air-borne acoustic signal transcutaneously or percutaneously to the skull bone or a vibrator for providing a structure-borne or liquid-borne acoustic signal. In some hearing devices, the output unit may include one or more output electrodes for providing the electric signals such as in a Cochlear Implant.

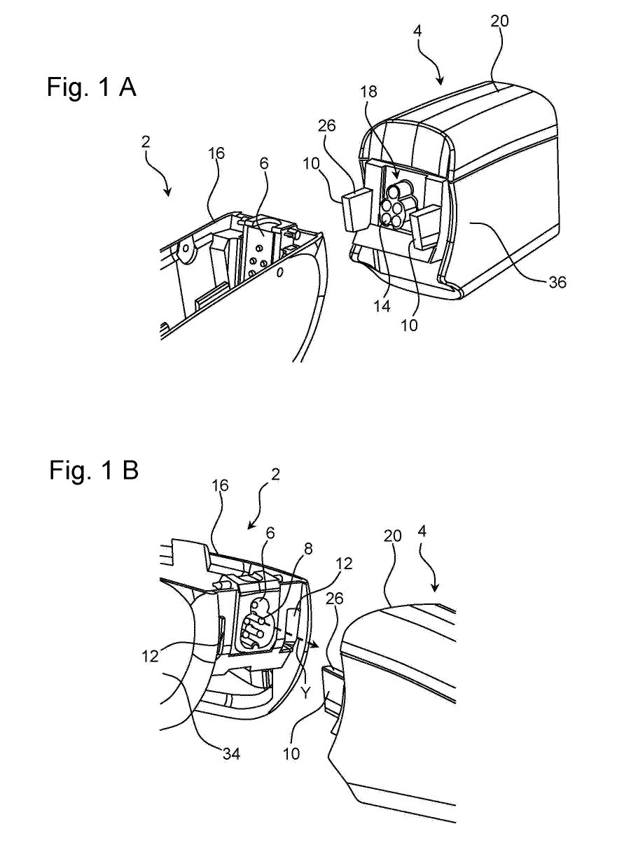

Now referring to FIG. 1 A, which illustrates a schematic perspective view of a hearing device 2 and an accessory device 4, the hearing device 2 comprises a shell member 16 and a connector 6 provided in the distal end of the hearing device 2.

The accessory device 4 comprises a housing 20 defining the periphery of the accessory device 4. The accessory device 4 further comprises a plug member 18 configured to be connected with the connector 6 of the hearing device in order to electrically connect the hearing device 2 and the accessory device 4.

The plug member 18 comprises five sleeves 14, wherein four of the sleeves are arranged in a square configuration and wherein the last sleeve 14 is arranged centrally at the top of the square configuration. The sleeves are shaped as cylindrical members adapted to receive corresponding pin members (see FIG. 1 B) of the connector 6 of the hearing device 2.

The accessory device 4 moreover comprises two guide arms 10 arranged at each side of the plug member 18. The guide arms 10 protrude from the plane structure at which the plug member 18 is provided. The plug member 18 is provided at the distal end of the accessory device 4. In FIG. 1 A, the distal end of the hearing device 2 faces the distal end of the accessory device 4. The upper surface 26 of the guide arms 10 is formed as a rectangular plane structure.

FIG. 1 B illustrates another schematic perspective view of the hearing device 2 and the accessory device 4 shown in FIG. 1 A. The hearing device 2 and the accessory device 4 are seen from another angle, in which the pins 8 of the connector 6 of the hearing device 2 are visible. It can be seen that the pins 8 protrude parallel to the same longitudinal axis Y. It can be seen that the pins 8 are basically cylindrically shaped.

At each side of the connector 6, a guide hole 12 is provided. The two guide holes 12 are configured to abuttingly and retainingly receive the guide arms of the accessory device 4. Hereby, a firm and stable connection between the hearing device 2 and the accessory device 4 can be achieved.

The shell member 16 of the hearing device 2 has a periphery 34 that may be manufactured in a plastic material e.g. by injection moulding.

The accessory device 4 comprises a housing 20 and two (of which only one is visible in FIG. 1 B) guide arms 10 protruding therefrom. The guide arms 10 are provided with a plane upper surface 26.

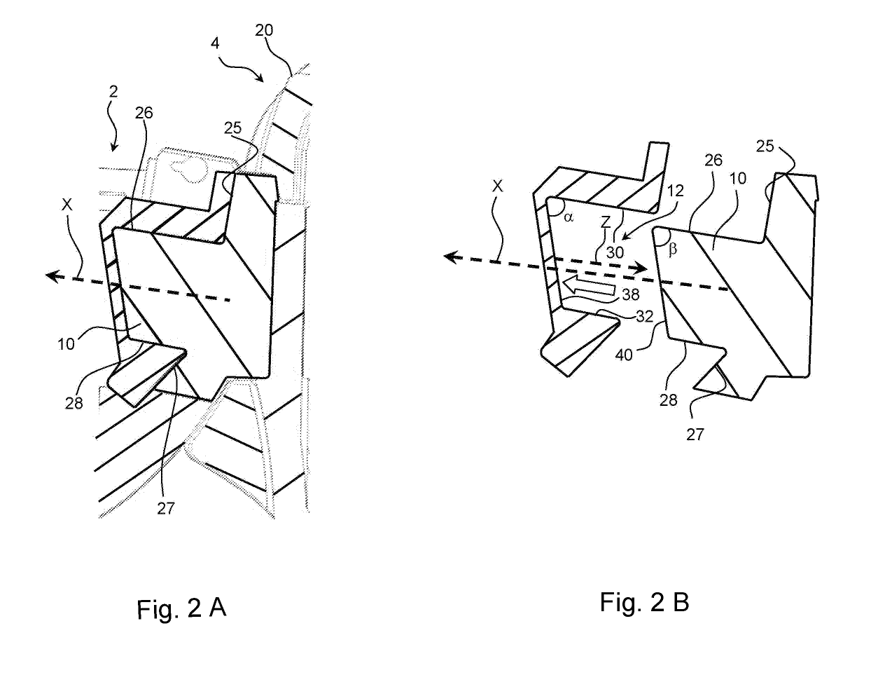

FIG. 2 A illustrates a schematic cross-sectional view of a hearing device 2 and an accessory device 4, wherein the accessory device 4 is mechanically and electrically connected to the hearing device 2.

The accessory device 4 comprises a housing 20 and a guide arm 10 having a longitudinal axis X and protruding from the housing 20. The guide arm 10 has been received by the guide hole of the hearing device 2. The guide hole of the hearing device 2 comprises a plane upper surface 26 and a plane lower surface 28 extending parallel to the upper surface 26 and to the longitudinal axis X of the guide arm 10. The guide arm 10 has been abuttingly and retainingly received by the guide hole of the hearing device 2.

FIG. 2 B shows a schematic cross-sectional view of a portion of the hearing device 2 and a portion of the accessory device 4 shown in FIG. 2 A. The portion of the hearing device 2 comprises a guide hole 12 having a plane upper receiving surface 30 and a plane lower receiving surface 32 extending parallel to the upper receiving 30. The hearing device 2 comprises guide holes 12 comprising a basically plane bottom surface 38 that is acute-angled relative to the upper receiving surface 30. The acute angle α between the bottom surface 38 and the upper receiving surface 30 is indicated.

The accessory device 4 comprises a guide arm 10 having a plane upper surface 26 and a plane lower surface 28 extending parallel to the upper surface 26. The guide arm 10 comprises a plane front surface 40 acute-angled relative to the upper surface 26. The acute angle β between the front surface 40 and the upper surface 26 is indicated.

The guide arm 10 is configured and shaped to be inserted into the guide hole 12 by being moved along the longitudinal axis X of the guide arm 10. The guide arm 10 is configured and shaped to be pulled back from the guide hole 12 by being moved along the longitudinal axis Z of the guide hole 12. The longitudinal axis Z of the guide hole 12 extends parallel to the longitudinal axis X of the guide arm 10.

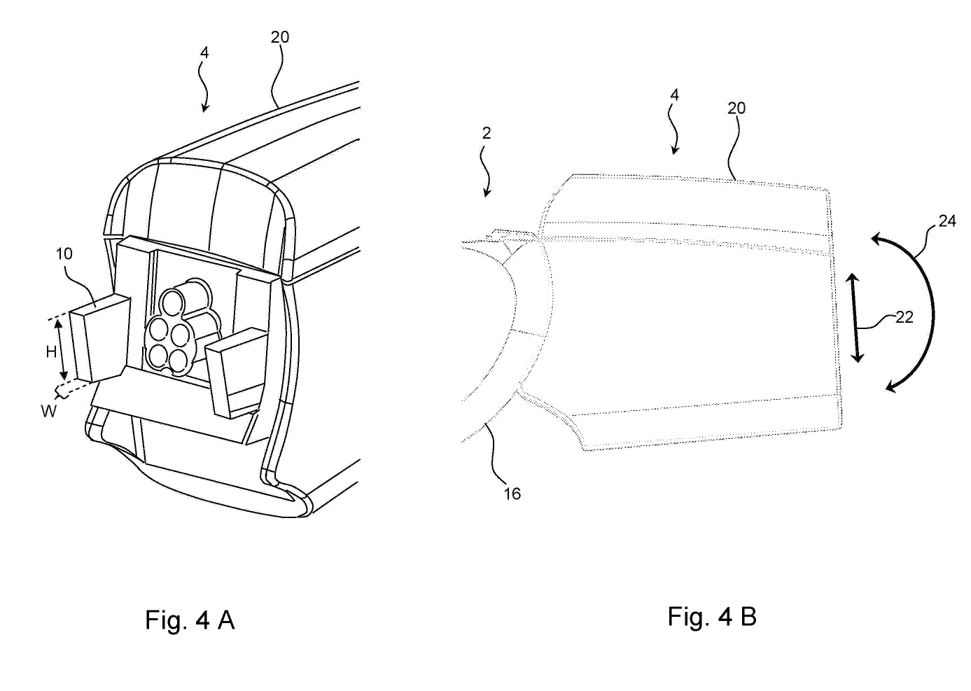

The guide arm 10 comprises a first support 25 extending substantially perpendicular to the upper surface 26. The first support 25 could extend at an angle in the range 80 to 110 degrees relative to the upper surface 26. A second support 27 extends at an acute angle relative to the lower surface 28. The acute angle here is preferably around 30 to 60 degrees. The first support 25 abut a part of the hearing device housing and help holding the guide arm 10 in the guide hole 12. The second support 27 abut a part of the hearing device housing opposite from the first support 25 and help holding the guide arm 10 in the guide hole 12. These first and second supports provides additional holding forces when the accessory is exposed to both rotation 24 and displacement 22 force as illustrated in FIG. 4 B. Further, the displacement force may be in other directions than the illustrated double arrow 22, e.g. perpendicular to the double arrow 22, or other directions.

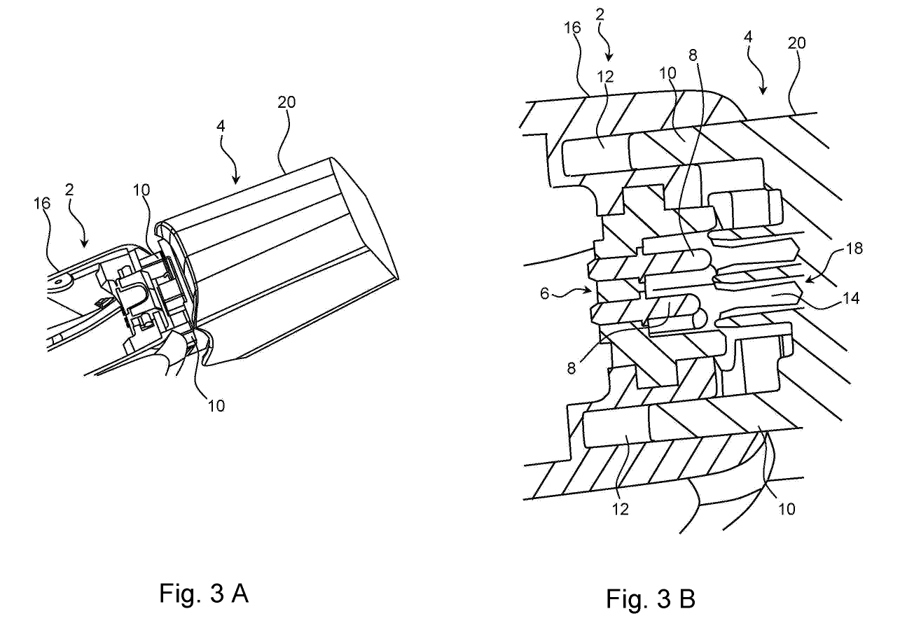

FIG. 3 A illustrates a schematic perspective view of a hearing device 2 and an accessory device 4, wherein the accessory device 4 is connected to the hearing device 2. The hearing device 2 that is seen from above and comprises a shell member 16 having guide holes that have abuttingly and retainingly received the guide arms 10 of the accessory device 4. The guide arms 10 of the accessory device 4 protrude from the housing 20 of the accessory device 4.

FIG. 3 B illustrates a schematic cross-sectional close-up view of a hearing device 2 and an accessory device 4, wherein the accessory device 4 is being mechanically and electrically connected to the hearing device 2.

The hearing device 2 comprises a shell 16 provided with two guide holes 12 into which two corresponding guide arms 10 have been partly inserted. The hearing device 2 comprises a connector 6 having a plurality of pins 8 extending parallel to each other. The pins 8 are configured to be received by a plug member 18 provided with corresponding sleeves 14 adapted to provide electric connection between the hearing device 2 and an accessory device 4 when the pins 8 have been inserted into the sleeves 14. The accessory device 4 has a housing 20.

FIG. 4 A illustrates a schematic perspective view of an accessory device 4. The accessory device 4 comprises a housing and two guide arms 10. The height H of the guide arms 10 is larger than the width W of the guide arms 10.

FIG. 4 B illustrates a schematic side view of a hearing device 2 and an accessory device 4, wherein the accessory device 4 is connected to the hearing device 2.

The hearing device 2 has a shell member 16 and the accessory device 4 has a housing 20. The use of guide arms and corresponding guide holes (see FIG. 3 B) makes the electrical and mechanical connection between the hearing device 2 and the accessory device 4 stable and resistant to both rotation 24 and displacement 22 between the hearing device 2 and the accessory device 4. Accordingly, the disclosure provides a robust and reliable mechanical and electrical connection between the hearing device 2 and the accessory device 4. The guide arms will take up any force that potentially could cause torsion or flexion of the pins of the hearing device 2. Accordingly, the use of guide holes configured to engagingly receive corresponding guide arms prevents stress of the pins. Therefore, the disclosure makes it possible to increase the service life of the accessory device 4 and establish an electrical connection between the hearing device 2 and the accessory device 4 even when the accessory device 4 has been connected to the hearing device 2 a considerable number of times.

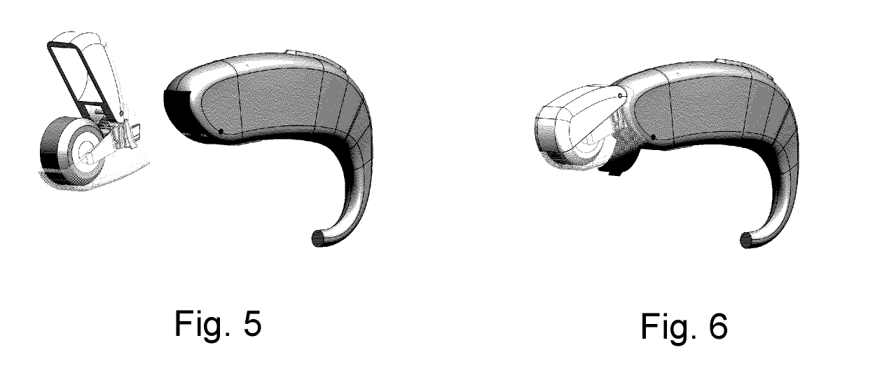

FIG. 5 schematically illustrates an accessory device comprising a battery. Here the battery in the accessory device is replaceable, allowing a user to carry one or more additional batteries, e.g. a pack of regular Zn-air batteries or the like, and in case the hearing aid main battery runs low the user may attached the accessory device to the hearing aid so as to provide additional power. Further, when a battery in the accessory rund low the user may re-place that battery if needed. Such an arrangement could be useful when the hearing aid or hearing device have a rechargeable battery that the user is not able to access, e.g. due to safety reasons, and the user need to recharge the rechargeable battery or provide auxiliary power to the hearing aid during use. The user is thus alleviated from brining a charger device, but merely a small, additional battery pack. Further, placing the hearing aid in a charger leaves the user at a disadvantage as he or she is then not alleviated from the hearing loss. Still further, the accessory device alleviates the burden of replacing small batteries in the hearing aid while the user is not at home and attaching the accessory device to the hearing aid is contemplated to be easier for the user.

FIG. 6. schematically illustrates the accessory device attached to the hearing aid.

The accessory device may be shaped to hold one or more types of batteries, e.g. 312 batteries or larger or smaller batteries.

As used, the singular forms “a,” “an,” and “the” are intended to include the plural forms as well (i.e. to have the meaning “at least one”), unless expressly stated otherwise. It will be further understood that the terms “includes,” “comprises,” “including,” and/or “comprising,” when used in this specification, specify the presence of stated features, integers, steps, operations, elements, and/or components, but do not preclude the presence or addition of one or more other features, integers, steps, operations, elements, components, and/or groups thereof. It will also be understood that when an element is referred to as being “connected” or “coupled” to another element, it can be directly connected or coupled to the other element, but an intervening element may also be present, unless expressly stated otherwise. Furthermore, “connected” or “coupled” as used herein may include wirelessly connected or coupled. As used herein, the term “and/or” includes any and all combinations of one or more of the associated listed items. The steps of any disclosed method is not limited to the exact order stated herein, unless expressly stated otherwise.

It should be appreciated that reference throughout this specification to “one embodiment” or “an embodiment” or “an aspect” or features included as “may” means that a particular feature, structure or characteristic described in connection with the embodiment is included in at least one embodiment of the disclosure. Furthermore, the particular features, structures or characteristics may be combined as suitable in one or more embodiments of the disclosure. The previous description is provided to enable any person skilled in the art to practice the various aspects described herein. Various modifications to these aspects will be readily apparent to those skilled in the art, and the generic principles defined herein may be applied to other aspects.

The claims are not intended to be limited to the aspects shown herein, but are to be accorded the full scope consistent with the language of the claims, wherein reference to an element in the singular is not intended to mean “one and only one” unless specifically stated, but rather “one or more.” Unless specifically stated otherwise, the term “some” refers to one or more.

Accordingly, the scope should be judged in terms of the claims that follow.

### LIST OF REFERENCE NUMERALS

2 Hearing device
4 Accessory device
6 Connector
8 Pin
10 Guide arm
12 Guide hole
14 Sleeve
16 Shell member
18 Plug member
20 Housing
22 Displacement
24 Rotation
25 Support
26 Upper surface
27 Support
28 Lower surface
30 Upper receiving surface
32 Lower receiving surface
34, 36 Periphery
38 Bottom surface
40 Front surface
X, Y, Z Longitudinal axis
H Height
W Width
α Angle
β Angle

1. A hearing device, such as a hearing aid, comprising a connector for a wired electrical connection between the hearing device and an accessory device, which connector comprises a number of connection members adapted to engage with corresponding connection members of a plug member of the accessory device, wherein the hearing device comprises:
one or more guide holes configured to engagingly receive corresponding guide arms of the accessory device or
one or more guide arms configured to be engagingly inserted into corresponding guide holes of the accessory device,
wherein the one or more guide arms having an upper surface extending parallel to a lower surface and the one or more guide arms comprising a basically plane front surface that is acute-angled relative to the upper surface or to the lower surface.

2. The hearing aid according to claim 1, wherein the hearing aid comprises two or more guide holds or guide arms, and wherein an even number of guide holes or guide arms are arranged symmetrically relative to the connector.

3. The hearing device according to claim 1, wherein the hearing device comprises two, three or four guide holes configured to engagingly receive corresponding guide arms of the accessory device.

4. The hearing device according to claim 1, wherein the hearing device comprises guide holes having a rectangular cross-section.

5. The hearing device according to claim 4, wherein the height of the guide holes is larger than the width of the guide holes.

6. The hearing device according to claim 2, wherein the connection members extend parallel to the longitudinal axis of the connection members of a plug member of the accessory device and wherein the longitudinal axis of the guide holes extend parallel to the longitudinal axis of the guide arms.

7. The hearing device according to claim 2, wherein the guide holes are provided next to the connector in less distance from the periphery of the hearing device than the connector.

8. The hearing device according to claim 7, wherein two guide holes are arranged at respective opposite sides of the connector.

9. The hearing device according to claim 1, wherein the hearing device further comprises a first support extending substantially perpendicular to the upper surface and/or second support extending at an acute angle relative to the lower surface.

10. A system comprising a hearing device according to claim 1 and an accessory device, wherein the accessory device comprises a plug member having a number of sleeves or pins, which sleeves or pins are adapted to engage with a corresponding connector of the hearing device for establishing a wired electrical connection between the accessory device and the hearing device, wherein the accessory device comprises:
one or more guide arms configured to be engagingly inserted into corresponding guide holes of the hearing device or
one or more guide holes configured to engagingly receive corresponding guide arms of the hearing device, and
wherein the one or more guide arms having an upper surface extending parallel to a lower surface and the one or more guide arms comprising a basically plane front surface that is acute-angled relative to the upper surface or to the lower surface.

11. The system according to claim 10, wherein the sleeves or pins extend parallel to the longitudinal axis of the guide arms.

12. The system according to claim 10, wherein the guide arms or guide holes of the accessory device are provided next to the plug member in less distance from the periphery of the accessory device than the plug member.

13. The system according to claim 10, wherein two guide holes or two guide arms are arranged at respective opposite sides of the plug member.

14. The system according to claim 11, wherein the accessory device comprises a battery, an FM antenna, a microphone, a direct audio input adaptor, an RF antenna, a telecoil, a coil for magnetic communication, a sensor, such as a temperature sensor or other type of sensor, a processor or a combination thereof.

15. A hearing aid comprising a connector part having a wired electrical connection established by a first number of connection members, the connector part configured to contact an accessory device, where the accessory device comprises corresponding connection members of a plug member of the accessory device, wherein the hearing device comprises:
one or more either guide holes or guide arms each configured to mate with corresponding guide arms or holes of the accessory device,
each of the one or more guide holes or guide arms include an upper surface and a parallel lower surface, connected by a plane front surface that is acute-angled relative to the upper surface or to the lower surface.

16. The hearing aid according to claim 15, wherein the hearing aid comprises two or more guide holes or guide arms, and wherein an even number of guide holes or guide arms are arranged symmetrically relative to the connector.

17. The hearing aid according to claim 15, wherein the hearing device comprises guide holes having a rectangular cross-section.

18. The hearing aid according to claim 15, wherein the guide arms comprises rounded edges.

19. The hearing aid according to claim 15, wherein the guide arms or guide holes have substantially similar or identical geometry.

20. The hearing aid according to claim 15, wherein the accessory device comprises or is a battery, an FM antenna, a microphone, a direct audio in-put adaptor, an RF antenna, a telecoil, a coil for magnetic communication, a sensor, such as a temperature sensor or other type of sensor, a processor or a combination thereof.
